(19) United States
(12) Patent Application Publication
(10) Pub. No.: US 2022/0327353 A1
(43) Pub. Date: Oct. 13, 2022

(54) KERNEL SIZE INDEPENDENT POOLING OPERATIONS

(71) Applicant: Advanced Micro Devices, Inc., Santa Clara, CA (US)

(72) Inventor: Aditya Chatterjee, Bangalore (IN)

(73) Assignee: Advanced Micro Devices, Inc., Santa Clara, CA (US)

(21) Appl. No.: 17/218,085

(22) Filed: Mar. 30, 2021

(51) Int. Cl. G06N 3/04

(52) U.S. Cl. CPC G06N 3/04

(57) ABSTRACT

Devices, methods, and systems for determining N-dimensional MaxPool or AvgPool for a M-dimensional input array. For each of N dimensions, in order from highest to lowest dimension i: the M dimensional input array is decomposed into 1 dimensional (1D) input arrays in the i^{th} dimension, 1D MaxPool or AvgPool is performed on each of the 1D input arrays in the i^{th} dimension to generate 1D output arrays in the i^{th} dimension, and the M dimensional input array is recomposed from the 1D output arrays in the i^{th} dimension to update the M-dimensional input array. In MaxPool, the updated M-dimensional input array is output as an M-dimensional output array. In AvgPool, each element of the updated M-dimensional input array is divided by a kernel size to form the M-dimensional output array.

### BACKGROUND

Convolutional Neural Networks (CNN) are an effective and widely used Machine Learning (ML) approach to a wide range of problems. Pooling operations are the second most computationally expensive operations in most CNN models (after Convolution operations). Maximum Pool (MaxPool) and Average Pool (AvgPool) are two of the most widely used types of pooling operations. The computation time of pooling operations impacts single-thread performance, inference latency, and throughput, in some cases.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a flow chart illustrating an example method for determining MaxPool for an input array of an arbitrary number of dimensions;

FIG. 4 is a flow chart illustrating an example method for determining MaxPool for an input array of an arbitrary number of dimensions;

FIG. 5 is a flowchart illustrating an example method for computing 1D MaxPool for a 1D input array;

FIG. 6 is a flow chart illustrating an example method for determining AvgPool for an input array of an arbitrary number of dimensions;

FIG. 7 is a flow chart illustrating an example method for determining AvgPool for an input array of an arbitrary number of dimensions; and

FIG. 8 is a flowchart illustrating an example method for computing 1D AvgPool for a 1D input array.

### DETAILED DESCRIPTION

Some implementations provide a method for determining N-dimensional MaxPool for a M-dimensional input array. For each of N dimensions, in order from highest to lowest dimension i: the M dimensional input array is decomposed into 1 dimensional (1D) input arrays in the i^{th} dimension, 1D MaxPool is performed on each of the 1D input arrays in the i^{th} dimension to generate 1D output arrays in the i^{th} dimension, and the M dimensional input array is recomposed from the 1D output arrays in the i^{th} dimension to update the M-dimensional input array. The updated M-dimensional input array is output as an M-dimensional output array.

In some implementations, the 1D output array for each of the 1D input arrays in the i^{th} dimension is calculated with respect to a kernel size. In some implementations, the kernel sizes of at least two of the i dimensions are different. In some implementations, determining the 1D output array comprises tracking a highest valued element of the 1D input array in a stack of pointers to elements of the 1D input array. In some implementations, determining the 1D output array comprises tracking the highest valued element of a 1D input array by links associated with each element of the 1D input array. In some implementations, tracking the highest valued element by following each of the links until reaching a link pointing to its own element.

Some implementations provide method for determining N-dimensional AvgPool for a M-dimensional input array. For each of N dimensions, in order from highest to lowest dimension i: the M-dimensional input array is decomposed into 1 dimensional (1D) input arrays in i^{th} dimension, 1D AvgPool is performed on each of the 1D input arrays in the i^{th} dimension to generate 1D output arrays in the i^{th}; and the M dimensional input array is recomposed from the 1D output arrays in the i^{th} dimension to update the M-dimensional input array. Each element of the updated M-dimensional input array is divided by a kernel size to form an M-dimensional output array. The M-dimensional output array is output.

In some implementations, the 1D output array for each of the 1D input arrays in the i^{th} dimension is calculated with respect to a kernel size. In some implementations, the kernel size is different for at least two of the i dimensions. In some implementations, a sum of elements of each of the 1D input arrays is accumulated in a corresponding sum array. In some implementations, determining the 1D output array comprises subtracting a value of an element of the sum array from a value of a different element of the sum array.

Some implementations provide an apparatus for determining N-dimensional MaxPool for a M-dimensional input array. The apparatus includes circuitry configured to, for each of N dimensions, in order from highest to lowest dimension i: decompose the M-dimensional input array into 1 dimensional (1D) input arrays in i^{th} dimension, perform 1D MaxPool on each of the 1D input arrays in the i^{th} dimension to generate 1D output arrays in the i^{th} dimension, and recompose the M dimensional input array from the 1D output arrays in the i^{th} dimension to update the M dimensional input array. The apparatus also includes circuitry configured to output the updated M-dimensional input array as an M-dimensional output array.

In some implementations, the apparatus includes circuitry configured to calculate the 1D output array for each of the 1D input arrays in the i^{th} dimension with respect to a kernel size. In some implementations, the kernel sizes of at least two of the i dimensions are different. In some implementations, the apparatus includes circuitry configured to determine the 1D output array by tracking a highest valued element of the 1D input array in a stack of pointers to elements of the 1D input array. In some implementations, the apparatus includes circuitry configured to determine the 1D output array by tracking the highest valued element of a 1D input array by links associated with each element of the 1D input array. In some implementations, the apparatus includes circuitry configured to track the highest valued element by following each of the links until reaching a link pointing to its own element.

Some implementations provide an apparatus for determining N-dimensional AvgPool for a M-dimensional input array. The apparatus includes circuitry configured to, for each of N dimensions, in order from highest to lowest dimension i: decompose the M-dimensional input array into 1 dimensional (1D) input arrays in i^{th} dimension, perform 1D AvgPool on each of the 1D input arrays in the i^{th} dimension to generate 1D output arrays in the i^{th}; and recompose the M dimensional input array from the 1D output arrays in the i^{th} dimension to update the M-dimensional input array. The apparatus also includes circuitry configured to divide each of element of the updated M-dimensional input array by a kernel size to form an M-dimensional output array. The apparatus also includes circuitry configured to output the M-dimensional output array. In some implementations, the apparatus includes circuitry configured to calculate the 1D output array for each of the 1D input arrays in the i^{th} dimension with respect to a kernel size.

In some implementations, the kernel size is different for at least two of the i dimensions. In some implementations, the apparatus includes circuitry configured to accumulate a sum of elements of each of the 1D input arrays in a corresponding sum array. In some implementations, the apparatus includes circuitry configured to determine the 1D output array by subtracting a value of an element of the sum array from a value of a different element of the sum array.

Some implementations provide a method for determining MaxPool for a 2 dimensional (2D) input array. A 2D input array is decomposed into 1 dimensional (1D) input arrays in a first dimension. A 1D MaxPool output array is determined for each of the 1D input arrays in the first dimension to form a 2D intermediate output array. The 2D intermediate output array is decomposed into 1D input arrays in a second dimension. A 1D MaxPool output array is determined for each of the 1D input arrays in the second dimension to form a 2D final output array. The 2D final output array is output.

In some implementations, the 1D MaxPool output array for each of the 1D input arrays in the first dimension is calculated with respect to a first kernel size, and the 1D MaxPool output array for each of the 1D input arrays in the second dimension is calculated with respect to a second kernel size. In some implementations, determining a 1D MaxPool output array includes tracking a highest valued element of a 1D input array in a stack of pointers to elements of the 1D input array. In some implementations, determining a 1D MaxPool output array includes tracking a highest valued element of a 1D input array by links associated with each element of the 1D input array. In some implementations, determining a 1D MaxPool output array includes tracking the highest valued element by following each of the links until reaching a link pointing to its own element.

Some implementations provide a method for determining AvgPool for a 2 dimensional (2D) input array. A 2D input array is decomposed into 1 dimensional (1D) input arrays in a first dimension. A 1D AvgPool output array is determined for each of the 1D input arrays in the first dimension to form a 2D intermediate output array. The 2D intermediate output array is decomposed into 1D input arrays in a second dimension. A 1D AvgPool output array is determined for each of the 1D input arrays in the second dimension to form a second 2D intermediate output array. Each of element of the second 2D intermediate output array is divided by a kernel size to form a 2D final output array. The 2D final output array is output.

In some implementations, the 1D MaxPool output array for each of the 1D input arrays in the first dimension is calculated with respect to a first kernel size. In some implementations, the 1D MaxPool output array for each of the 1D input arrays in the second dimension is calculated with respect to a second kernel size. In some implementations, accumulating a sum of elements of each of the 1D input arrays is accumulated in a corresponding sum array. In some implementations, determining a 1D AvgPool output array includes subtracting a value of an element of the sum array from a value of a different element of the sum array.

Some implementations provide an apparatus for determining MaxPool for a 2 dimensional (2D) input array. The apparatus includes circuitry configured to decompose a 2D input array into 1 dimensional (1D) input arrays in a first dimension. The apparatus also includes circuitry configured to determine a 1D MaxPool output array for each of the 1D input arrays in the first dimension to form a 2D intermediate output array. The apparatus also includes circuitry configured to decompose the 2D intermediate output array into 1D input arrays in a second dimension. The apparatus also includes circuitry configured to determine a 1D MaxPool output array for each of the 1D input arrays in the second dimension to form a 2D final output array. The apparatus also includes circuitry configured to output the 2D final output array.

In some implementations, the apparatus includes circuitry configured to calculate the 1D MaxPool output array for each of the 1D input arrays in the first dimension with respect to a first kernel size, and to calculate the 1D MaxPool output array for each of the 1D input arrays in the second dimension with respect to a second kernel size. In some implementations, the apparatus includes circuitry configured to determine a 1D MaxPool output array by tracking a highest valued element of a 1D input array in a stack of pointers to elements of the 1D input array. In some implementations, the apparatus includes circuitry configured to determine a 1D MaxPool output array by tracking a highest valued element of a 1D input array by links associated with each element of the 1D input array. In some implementations, the apparatus includes circuitry configured to track the highest valued element by following each of the links until reaching a link pointing to its own element.

Some implementations provide an apparatus for determining AvgPool for a 2 dimensional (2D) input array. The apparatus includes circuitry configured to decompose a 2D input array into 1 dimensional (1D) input arrays in a first dimension. The apparatus also includes circuitry configured to determine a 1D AvgPool output array for each of the 1D input arrays in the first dimension to form a 2D intermediate output array. The apparatus also includes circuitry configured to decompose the 2D intermediate output array into 1D input arrays in a second dimension. The apparatus also includes circuitry configured to determine a 1D AvgPool output array for each of the 1D input arrays in the second dimension to form a second 2D intermediate output array. The apparatus also includes circuitry configured to divide each element of the second 2D intermediate output array by a kernel size to form a 2D final output array. The apparatus also includes circuitry configured to output the 2D final output array.

In some implementations, the apparatus includes circuitry configured to calculate the 1D AvgPool output array for each of the 1D input arrays in the first dimension with respect to a first kernel size. In some implementations, the apparatus includes circuitry configured to calculate the 1D AvgPool output array for each of the 1D input arrays in the second dimension with respect to a second kernel size. In some implementations, the apparatus includes circuitry configured to accumulate a sum of elements of each of the 1D input arrays in a corresponding sum array. In some implementations, the apparatus includes circuitry configured to determine a 1D AvgPool output array by subtracting a value of an element of the sum array from a value of a different element of the sum array.

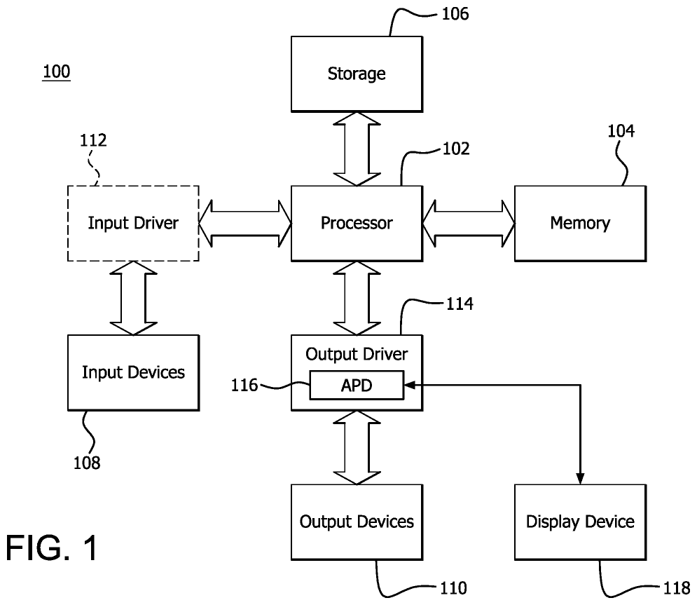

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

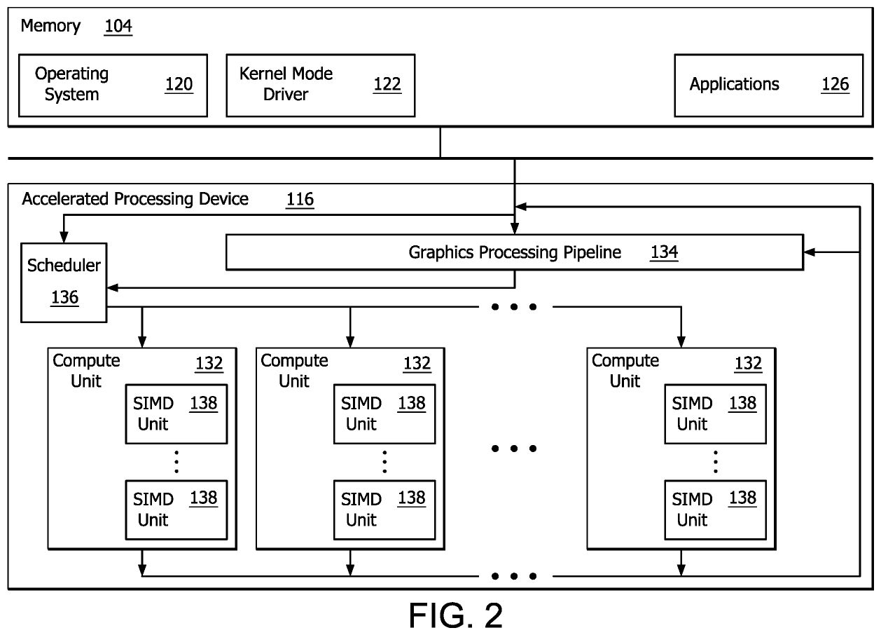

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The theoretical minimum computation time for pooling operations, such as 2-dimensional MaxPool and AvgPool, can be expressed as having an O(N²) time complexity. In other words, T(n), or, the time required to perform the pooling operation on n bits of input approaches n as the number of input bits increases. Current approaches to performing such pooling operations on a computing device (e.g., as in Intel™ DNNL™ and TensorFlow™) involve brute force calculations that do not achieve the theoretical minimum computation time and are typically improvable only based on general implementation techniques.

For example, some current approaches to performing pooling operations on a computing device use a block data format and/or using parallelized input dimensions, such as channel and batch size, to attempt to improve the computation time of pooling operations, however, none of these approaches improve the time complexity over brute force methods currently used to perform pooling operations on a computing device, and none of these approaches achieves the minimum theoretical time complexity for such pooling operations using a computing device.

Time complexity for brute force approaches to 2D MaxPool and 2D AvgPool are expressed as O(N×M×K1×K2) for an input image of size N×M, and a kernel size of K1×K2.

Accordingly, some implementations provide methods, devices, and systems for computing MaxPool and/or AvgPool using a computing device which improve on current approaches. In some implementations, advantageously, the computation time for MaxPool and/or AvgPool achieves a minimum computation time on a computing device having O(N²) time complexity. In some implementations, advantageously, the computation time is independent of kernel size.

It is noted that while various methods, devices, and systems for MaxPool and/or AvgPool computations herein are described in examples relating to 2D MaxPool and/or 2D AvgPool operations on a computing device, these techniques are also applicable to higher or lower dimensional inputs and/or other features such as stride and padding (e.g., using 1D, or 3D, 4D, or higher dimensioned MaxPool and/or AvgPool).

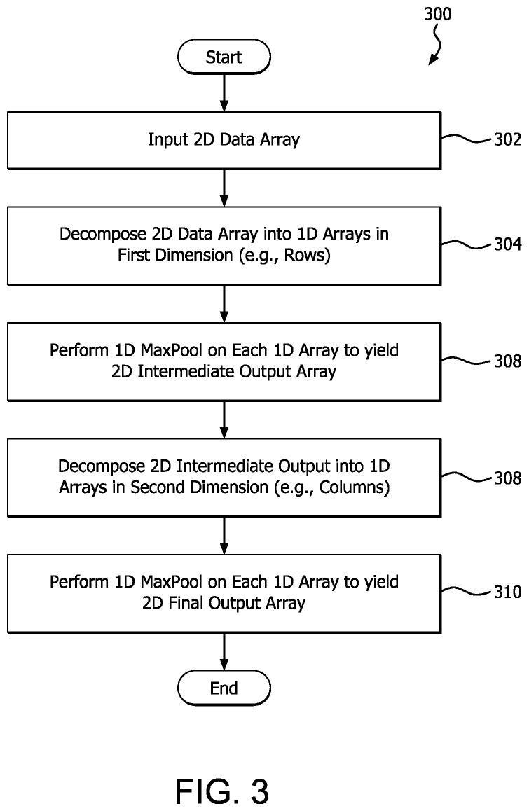

FIG. 3 is a flow chart illustrating an example method 300 for determining MaxPool for an input array of 2 dimensions on a computing device. The method is expandable to any desired number of dimensions, as further discussed herein. Example method 300 is implementable using any suitable hardware and/or software, such as device 100 or components thereof, e.g., as shown and described with respect to FIGS. 1 and 2.

Example method 300 is discussed with respect to a 2D input array which is input in step 302, however it is noted that an input array of any desired number of dimensions is possible in some implementations. Table 1 shows the values of the example 2D input array.

TABLE 1
2D Input Array

| | | |
|---|---|---|
| 1 | 4 | 3 |
| 2 | 5 | 10 |
| 11 | 10 | −1 |

For example, in order to compute the 2D MaxPool result for an example 2D input array, the 2D input array is decomposed into 1D arrays in a first dimension (the row dimension in this example) in step 304. A 1D MaxPool operation is performed on each of these 1D arrays to yield an intermediate 2D result for the first dimension in step 306. The example intermediate 2D result is shown in Table 2.

TABLE 2
Intermediate 2D
MaxPool Result

| | |
|---|---|
| 4 | 4 |
| 5 | 10 |
| 11 | 10 |

This intermediate output is decomposed into 1D arrays in the second dimension (the column dimension in this example) in step 308. A 1D MaxPool operation is performed on each of these 1D arrays to yield a 2D intermediate result for the second dimension in step 310. The 2D intermediate result for the second dimension is shown in Table 3.

TABLE 3
Second Intermediate
2D MaxPool Result

| | |
|---|---|
| 5 | 10 |
| 11 | 10 |

For higher dimensionality MaxPool operations on input arrays of higher dimensions, an intermediate result is generated and decomposed into 1D arrays for 1D MaxPool operations for each further dimension until all dimensions have been calculated. The final intermediate result (the second intermediate 2D MaxPool Result for this example 2D case) is the final result for 2D MaxPool.

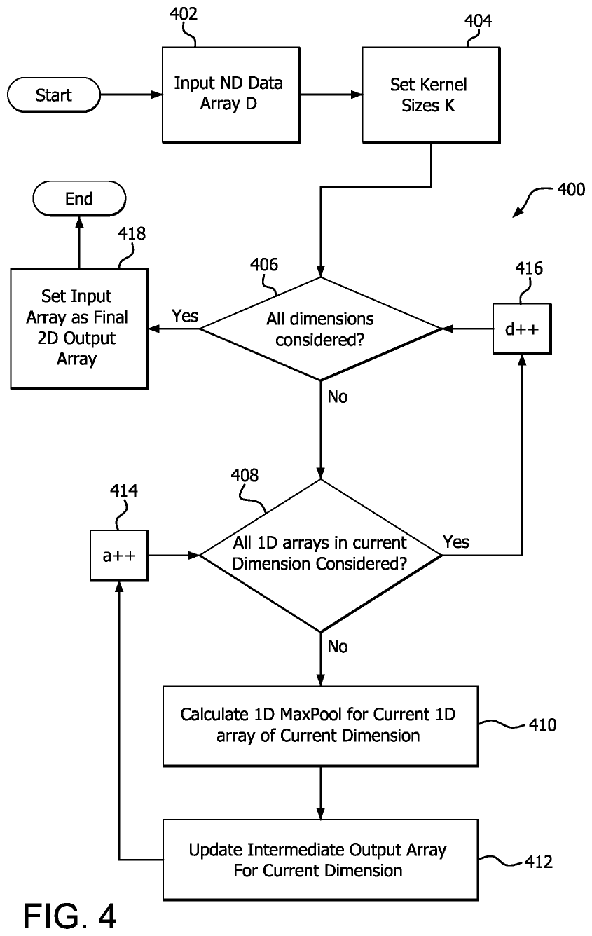

FIG. 4 is a flowchart illustrating an example method 400 for MaxPool on an input array of arbitrary dimensions on a computing device. The method is expandable to any desired number of dimensions, as further discussed herein. Example method 400 is implementable using any suitable hardware and/or software, such as device 100 or components thereof, e.g., as shown and described with respect to FIGS. 1 and 2. In some implementations, example method 400 is a more detailed description of method 300 as shown and described with respect to FIG. 3, and is described using the same example 2D input array.

In step 402, the 2D array is input for MaxPool computation. The example input array is 2D with one row dimension, and one column dimension. The example input array is 3 elements in width (or, row size of 3), and 3 elements in height (or, column size of 3). Table 4 shows values of the example 2D input array.

TABLE 4
2D Input Array

| | | |
|---|---|---|
| 1 | 4 | 3 |
| 2 | 5 | 10 |
| 11 | 10 | −1 |

In step 404, kernel sizes are set for each dimension of the 2D input array. In this example, the kernel sizes are 2 for the row dimension, and 2 for the column dimension. After the 2D input array and the kernel sizes are input in steps 402 and 404, an iteration counter d is initialized to 0 for tracking each dimension, and an iteration counter a is initialized to 0 for tracking each array in a dimension. It is noted that the use of an index variable is only a convenient example; any other suitable approach to tracking which dimension and/or array is under consideration is usable in other implementations. The illustrated order of steps 402, 404, and initialization of the iteration counters, is simply for convenience. These steps are implementable in any suitable order, simultaneously, and/or concurrently, as desired.

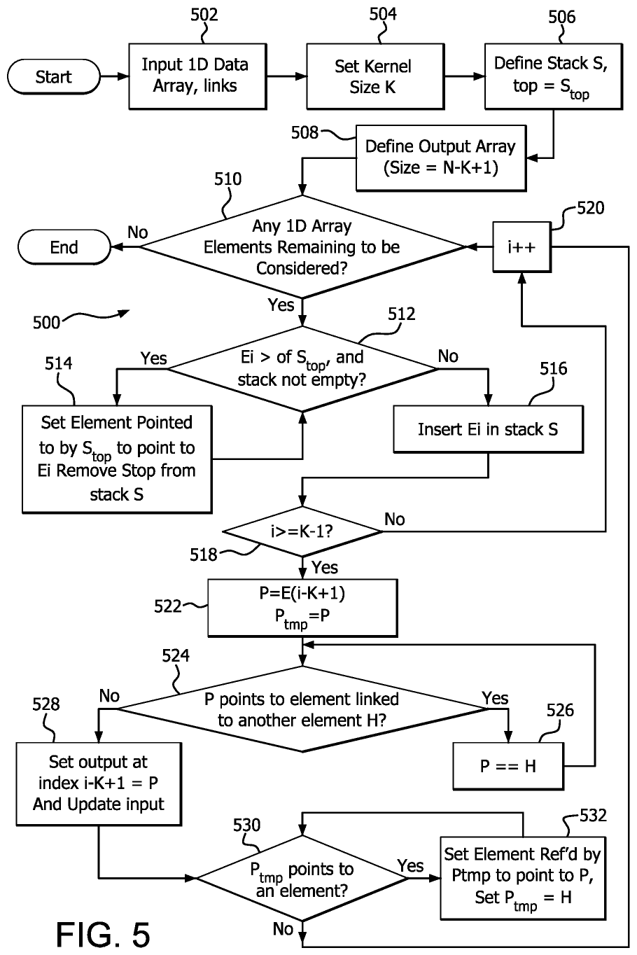

On condition 406 that not all dimensions of the 2D input array have been considered yet (i.e., d<the number of dimensions) and on condition 408 that not all 1D arrays in the current dimension have been considered yet (i.e., a<the number of arrays in the current dimension), a 1D MaxPool operation is carried out on the a^{th} array of the d^{th} dimension in step 410. In this example, the 0^{th} dimension corresponds to rows of the 2D input array, and array 0 is the first row. Accordingly, the values of this 1D array are as shown in Table 5. The 1D MaxPool operation carried out on the 1D array in step 410 is described in detail with respect to FIG. 5.

TABLE 5

| | | |
|---|---|---|
| 1 | 4 | 3 |

FIG. 5 is a flowchart illustrating an example method 500 for computing 1D MaxPool on a computing device. The 1D input array shown in Table 5 is input to the 1D MaxPool operation in step 502. Table 5 shows example 1D input array D, which includes 3 elements E. The size of array D is referred to as D_{size}, and is 3 in this example. The elements are indexed and referred to as E₀, E₁, E₂, respectively, in this example. Each element is associated with a value. In this example, E₀ is associated with the value 1, E₁ is associated with the value 4, and E₂ is associated with the value 3. Each element is also associated with a link to an element in the input array D. Initially, each link points to its own element (or in some implementations is empty or blank, containing no link). Each element, its associated value, and its associated link, are illustrated in Table 6.

TABLE 6

| | 1D Input Array | | |
|---|---|---|---|
| Element: | E₀ | E₁ | E₂ |
| Value: | 1 | 4 | 3 |
| Link: | E₀ | E₁ | E₂ |

In this example, an index variable i is used to track which element E is under consideration at various points in the method, and accordingly, i is initialized to 0 at this point (i==0). It is noted that the use of a counting variable to track elements is only a convenient example; any other suitable approach to tracking which element E is under consideration is usable in other implementations.

In step 504, a kernel size K is set for the 1D MaxPool operation. In this example, the size K of the MaxPool kernel is 2, based on the kernel set for this dimension earlier in step 404, as shown and described with respect to FIG. 4.

In step 506, a stack is defined to identify links associated with each element. It is noted that the link state is trackable in any suitable manner, such as an array, vector, pointer, or any other suitable structure. Table 7 illustrates an example stack having a top Sₜₒₚ and with all elements empty.

TABLE 7
Stack

| Sₜₒₚ | | |
|---|---|---|
| — | — | — |

In Step 508, a 1D output array of size N−K+1 is defined for storing the output of the 1D MaxPool operation on input array D. Table 8 shows the initialized output array.

TABLE 8
1D Output

The illustrated order of steps 502, 504, 506, and 508, is simply for convenience. These steps are implementable in any suitable order, simultaneously, and/or concurrently, as desired.

On condition 510 that any of the elements E of array D have not yet been evaluated, the 1D MaxPool operation proceeds. Here, since none of the elements of array D have yet been considered (i.e., i=0, i<(D_{size})) the first element E₀ is considered (i.e., Eᵢ, where i=0). Accordingly, Ei is set to the value of the first element of the input array (i.e., Eᵢ==1).

Next, it is determined how the value of Ei relates to the stack. This is based on whether the value of the current array entry, Ei, is greater than the value of an array entry at the top of the stack (i.e., Sₜₒₚ), and whether the stack S is empty.

On condition 512 that Eᵢ>the value of Sₜₒₚ, and the stack S is not empty (the stack empty aspect of this condition is omissible in some implementations where it is understood that the first element of the top of the stack does not exist when the stack is empty), the current Sₜₒₚ is removed from stack S, and the element E of array D which is currently pointed to by Sₜₒₚ is set to link the current Eᵢ in step 514, after which the element E of array D which is currently pointed to by Sₜₒₚ is removed from the stack S. Otherwise, on condition 512 that Eᵢ!>the value of Sₜₒₚ or that the stack S is empty, Eᵢ is inserted into the stack S in step 516.

Here, the stack is currently empty. Accordingly, the link to element Eᵢ is inserted into the stack in step 516. Since the stack is empty, this places the value of Eᵢ at the Sₜₒₚ position in stack S, as shown in Table 9. Table 10 shows the current state of the values and links associated with input array D.

TABLE 9
Stack

| Sₜₒₚ | | |
|---|---|---|
| E₀ | — | — |

TABLE 10
1D array D

| | | |
|---|---|---|
| 1 | 4 | 3 |

Link

| | | |
|---|---|---|
| E₀ | E₁ | E₂ |

After inserting Ei into stack S, a determination is made as to whether the index number i of element Ei under consideration is greater than or equal to K−1. This determination is made so that a sufficient number of elements have been considered (i.e., K elements—a complete kernel) before further calculations are made on the kernel. Accordingly, on condition 518 that i>=K−1, the process continues, otherwise, i is incremented at step 520 and the process returns to step 510 for consideration of the next element. Here, element E₀ is under consideration, and 0 is not greater than or equal to one less than the kernel size (i.e., 0 !>=2−1). Accordingly, i is incremented (i.e., i==1) at step 520 and the flow returns to condition 510.

On condition 510 that further elements Ei of array D remain to be evaluated, the 1D MaxPool operation proceeds. Here, i=1, and not all elements of array D have yet been considered (i<(D_{size})). Accordingly, the next element Eᵢ is considered (i.e., i=1), and Eᵢ is set to the value of the next element, E₁, of the input array (i.e., Eᵢ==4).

Next, it is determined how the value of Ei relates to the stack. On condition 512 that Eᵢ>the value of Sₜₒₚ, and the stack S is not empty, the current Sₜₒₚ is removed from stack S, and the element E of array D which is currently pointed to by Sₜₒₚ is set to link the current Eᵢ in step 514, after which the element E of array D which is currently pointed to by Sₜₒₚ is removed from the stack S. Otherwise, on condition 512 that Eᵢ!>the value of Sₜₒₚ or the stack S is empty, Eᵢ is inserted into the of the stack S in step 516.

Here, since E₁>Sₜₒₚ (i.e., 4>1), the element E₀ of array D which is currently pointed to by Sₜₒₚ is set to link the current E₁ in step 514, after which the element E₀ of array D which is currently pointed to by Sₜₒₚ is removed from the stack S in step 514, and the flow returns to 512. Table 11 shows the state of the stack S, and Table 12 shows the state of the links associated with input array D at this point.

TABLE 11
Stack

| Sₜₒₚ | | |
|---|---|---|
| — | — | — |

TABLE 12
1D array D

| | | |
|---|---|---|
| 1 | 4 | 3 |

Link

| | | |
|---|---|---|
| E₁ | E₁ | E₂ |

On condition A5, since the stack is empty at this point, the value of the current input element Ei is inserted into stack S. Since E₁=4, the value 4 is inserted into the empty stack S at Sₜₒₚ in step A7. Table 13, shows the state of the stack S and Table 14 shows the state of the links associated with input array D at this point.

TABLE 13
Stack

| Sₜₒₚ | | |
|---|---|---|
| E₁ | — | — |

TABLE 14
1D array D

| | | |
|---|---|---|
| 1 | 4 | 3 |

Link

| | | |
|---|---|---|
| E₁ | E₁ | E₂ |

After inserting Ei into stack S in 516, it is determined whether the index number i of element Ei under consideration is greater than or equal to K−1 at condition 518. Accordingly, on condition 518 that i>=K−1, a full kernel has been considered, and the process proceeds to determine a max value for the kernel by traversing the various links of input array D in steps 522-532.

Here, element E₁ is under consideration, and 1 is greater than or equal to one less than the kernel size (i.e., 1>=2−1). In other words, a full kernel has been considered at this point, and a MaxPool result is determined for this kernel by traversing the various links of input array D in steps 522-532. Accordingly, the flow proceeds to step 522 in this example.

In step 522, a pointer P is set point to the value of the element of the input array at index i−K+1, and a temporary pointer Pₜₘₚ is set to the same value. Pₜₘₚ is the first element in the current kernel. P is the maximum element in the current kernel. We traverse the elements of the input array based on Pₜₘₚ to determine P as the maximum element. Here, (i−K+1)=(1−2+1)=0; accordingly, P==E₀, which has a value of 1, and Pₜₘₚ==P. The pointer P tracks the max value for the current kernel as the links of input array D are traversed in subsequent steps to calculate the maximum value for the current kernel, and the temporary pointer Pₜₘₚ keeps track of the first element in the current kernel which is used in subsequent steps to update the links of elements in current kernel.

On condition 524 that the input array element pointed to by P (E₀ in this case) is associated with a link to a different input array element H, P is set to point to that input array element. In this case, array element E₀ is associated with a link to a different element, H=E₁ (which holds the value 4). Accordingly, the flow proceeds to step 526, where P is set to the value of H (i.e., P==H) and the flow returns to condition 524. In this instance, P==E₁ and the flow returns to 524. In this way, the method traverses the links currently associated with the input array D to determine a max value for the current kernel.

The element P is now pointing to element E₁ (which has a value of 4). At this point, the input array element pointed to by P (E₁ in this case) is not associated with a link to a different input array element H (i.e., it points to itself in this implementation, or is blank or empty in other implementations). Accordingly, on this condition 524 that P does not point to another input array element, an output array element at index i−K+1 is set to the value of P at step 528. Here, index 1−2+1=0. Accordingly, in step 528, the output array element 0 is set to the value currently associated with P, which is 4 in this instance (in some implementations, the output array element is set to point to the entry associated with P). Table 15 shows the state of the output array at this point. It is noted that the size of the output array is K−1 less the size of the input, provided that other parameters, such as stride and padding do not contribute to the size (e.g., where stride=1 and padding=0). Considering these parameters, the output size=(input size+padding left+padding right−kernel size)/(stride)+1.

TABLE 15
1D Output
4

After the max value for the current kernel is output to the output array in 528, the links in the input array are updated in if needed on condition 530. Accordingly, on condition 530 that the input array entry pointed to by Pₜₘₚ is linked to a different element of the input array, the link for that input array entry link is updated to point to the entry pointed to by P in step 532. Here, Pₜₘₚ points to input array entry E₀, which has a value of 1, and which points to element E₁, which has a value of 4. Accordingly, the flow proceeds to step 532. In step 532, input array entry E₀ already points to E₁ (i.e., it already points to P), and Pₜₘₚ is updated to point to H (i.e., Pₜₘₚ==E₁ in this case) and the flow returns to 530.

Here, Pₜₘₚ points to element E₁ of the input array, which is not linked to any other element. Accordingly, on condition 530 that Pₜₘₚ does not point to an input array element that is linked to another element, the index i is incremented in step 520 and the flow returns to condition 510.

On condition 510 that further elements Ei of input array D remain to be evaluated, the method proceeds. Here, i=2 currently, and all elements of array D have not yet been considered (i.e., i<(D_{size})). Accordingly, the next element E₂ is considered (i.e., Ei, where i=2). Accordingly, Ei is set to the i^{th} element of the input array (i.e., Ei==3).

On condition 512 that Eᵢ>the value of Sₜₒₚ, and the stack S is not empty, the current Sₜₒₚ is removed from stack S, and the element E of array D which is currently pointed to by Sₜₒₚ is set to link the current Eᵢ in step 514, after which the element E of array D which is currently pointed to by Sₜₒₚ is removed from the stack S. Otherwise, on condition 512 that Ei!>the value of Sₜₒₚ or the stack S is empty, Eᵢ is inserted into the of the stack S in step 516.

Here, since E₂!>Sₜₒₚ (i.e., 3 !>4), is E₂ is inserted into the of stack S in step 516. Table 16, shows the state of the stack S and the Table 17 shows the state of the links associated with input array D at this point.

TABLE 16
Stack
Sₜₒₚ

| | | |
|---|---|---|
| E₁ | E₂ | — |

TABLE 17
1D array D

| | | |
|---|---|---|
| 1 | 4 | 3 |

Link

| | | |
|---|---|---|
| E₁ | E₁ | E₂ |

After inserting Ei into stack S in 516, it is determined whether the index number i of element Ei under consideration is greater than or equal to K−1 at condition 518. Accordingly, on condition 518 that i>=K−1, a full kernel has been considered, and the process proceeds to determine a max value for the kernel by traversing the various links of input array D in steps 522-532.

Here, element E₂ is under consideration, and 2 is greater than or equal to one less than the kernel size (i.e., 2>=2−1). In other words, a full kernel has been considered at this point, and a MaxPool result is determined for this kernel by traversing the various links of input array D in steps 522-532. Accordingly, the flow proceeds to step 522 in this example.

In step 522, a pointer P is set to point to the element of the input array at index i−K+1, and a temporary pointer Pₜₘₚ is set to the same value. Here, (i−K+1)=(2−2+1)=1; accordingly, P==E₁, which has a value of 4, and Pₜₘₚ==P. The pointer P tracks the max value for the current kernel as the links of input array D are traversed in subsequent steps to calculate the maximum value for the current kernel, and the temporary pointer Pₜₘₚ keeps track of the first element in the current kernel which is used in subsequent steps to update the links of elements in current kernel.

On condition 524 that the input array element pointed to by P (E₁ in this case) is associated with a link to a different input array element H, P is set to point to that input array element. The value of P is currently pointing to input element E₁. At this point, the input array element pointed to by P (E₁ in this case) is not associated with a link to a different input array element H (i.e., it points to itself, or is blank or empty in other implementations). Accordingly, on this condition 524 that P does not point to another input array element, an output array element at index i−K+1 is set to the value of P at step 528. Here, index 1−2+1=0. Accordingly, in step 528, the output array element 1 is set to the value currently associated with P, which is 4 in this instance (in some implementations, the output array element is set to point to the entry associated with P). Table 18 shows the state of the 1D output array at this point.

TABLE 18
1D Output

| | |
|---|---|
| 4 | 4 |

After the max value for the current kernel is output to the output array in 528, the links in the input array are updated if needed. Accordingly, on condition 530 that the input array entry pointed to by Pₜₘₚ is linked to a different element of the input array, the link for that input array entry link is updated to point to the entry pointed to by P in step 532. Here, Pₜₘₚ points to input array entry E₁, which has a value of 4, and which does not point to any other elements. Accordingly, there is no need to update the links in the input array, and on condition 530 that Pₜₘₚ does not point to an input array element that is linked to another element, index i is incremented in step 520 and the flow returns to condition 510.

On condition 510 that further elements Ei of input array D remain to be evaluated, the method proceeds. Here, i=3 currently, and all elements of array D have been considered (i.e., i!<(Dsize)). Accordingly, the 1D MaxPool operation is complete with respect to the current input array D, and the process ends.

At this point, the 1D MaxPool output has been calculated for the first row of the 2D input array, and the flow returns to step 410, shown and described with respect to FIG. 4. Step 410 is now complete, and the process continues to step 412, where the intermediate output array for the current dimension is updated with the values calculated by the 1D MaxPool operation. Here, the first row of the intermediate output array is updated with the values of the 1D MaxPool of the first row of the first dimension of the 2D input array. Table 19 shows the state of the intermediate output array at this point.

TABLE 19
Intermediate
Output

| | |
|---|---|
| 4 | 4 |

After the intermediate output array is updated in step 412, the array counter a is incremented in step 414 (a=1), and the flow continues to condition 408. On condition 408 that not all 1D arrays in the current dimension have been considered (i.e., a<the number of arrays in the current dimension), a 1D MaxPool operation is carried out on the a^{th} array of the d^{th} dimension in step 410. In this example, the 0^{th} dimension corresponds to rows of the input 2D array, and array 1 is the second row, shown in Table 20.

TABLE 20

| | | |
|---|---|---|
| 2 | 5 | 10 |

Following the 1D MaxPool operations described with respect to FIG. 5, as described earlier, the 1D output array after 1D MaxPool is complete on the current 1D input array D is shown in Table 21:

TABLE 21
1D Output

| | |
|---|---|
| 5 | 10 |

At this point, the 1D MaxPool output has been calculated for the second row of the 2D input array, and the flow returns to step 410, shown and described with respect to FIG. 4. Step 410 is now complete, and the process continues to step 412, where the intermediate output array for the current dimension is updated with the values calculated by the 1D MaxPool operation. Here, the second row of the intermediate output array is updated with the values of the 1D MaxPool of the second row of the first dimension of the 2D input array. Table 22 shows the state of the intermediate output array at this point.

TABLE 22
Intermediate
Output

| | |
|---|---|
| 4 | 4 |
| 5 | 10 |

After the intermediate output array is updated in step 412, the array counter a is incremented in step 414 (a=2), and the flow continues to 408. On condition 408 that not all 1D arrays in the current dimension of the 2D input array have been considered (i.e., a<the number of arrays in the current dimension), a 1D MaxPool operation is carried out on the a^{th} array of the d^{th} dimension in step 410. In this example, the 0^{th} dimension corresponds to rows of the input 2D array, and array 2 is the third row, shown in Table 23.

TABLE 23

| | | |
|---|---|---|
| 11 | 10 | −1 |

Following the operations of the 1D MaxPool operation illustrated in FIG. 5, the intermediate output array after 1D MaxPool is complete on 1D input array D is shown in Table 24:

TABLE 24
1D Output

| | |
|---|---|
| 11 | 10 |

At this point, the 1D MaxPool output has been calculated for the third row of the 2D input array, and the flow returns to step 410, shown and described with respect to FIG. 4. Step 410 is now complete, and the process continues to step 412, where the intermediate output array for the current dimension is updated with the values calculated by the 1D MaxPool operation. Here, the third row of the intermediate output array is updated with the values of the 1D MaxPool of the third row of the first dimension of the 2D input array. Table 25 shows the state of the intermediate output array at this point.

TABLE 25
Intermediate
Output

| | |
|---|---|
| 4 | 4 |
| 5 | 10 |
| 11 | 10 |

After the intermediate output array is updated in step 412, the array counter a is incremented in step 414 (a=3), and the flow continues to 408. On condition 408 that all 1D arrays in the current dimension have been considered (i.e., a!<the number of arrays in the current dimension—here, 3!<3), the intermediate output array is set as the 2D input array, dimension counter d is incremented in step 416, and the flow proceeds to 406.

The 2D input array now reflects what was the intermediate output array, the intermediate output array is cleared, and array counter a is reset to 0. It is noted that the input array is still a 2D array, however it is now 2 elements in width, and 3 elements in height. The current input data array is shown in Table 26, and the cleared intermediate output array is shown in Table 27.

TABLE 26
Input

| | |
|---|---|
| 4 | 4 |
| 5 | 10 |
| 11 | 10 |

TABLE 27
Intermediate
Output

On condition 406 that not all dimensions of the input array have been considered yet (i.e., d<the number of dimensions) and on condition 408 that not all 1D arrays in the current dimension of the current 2D input array have been considered (i.e., a<the number of arrays in the current dimension), a 1D MaxPool operation is carried out on the a^{th} array of the d^{th} dimension in step 410. In other words, since dimension 1<2, and array 0<2, a 1D MaxPool operation is carried out on the 0^{th} array of the 1^{th} dimension in step 410. In this example, the 1^{th} dimension corresponds to the columns of the current input 2D array, and array 0 is the first column, shown in Table 28.

TABLE 28
4
5
11

Transposing this array for convenience of illustration, the 1D input array D, and its links for purposes of the 1D MaxPool operation of FIG. 5 are shown in Table 29:

TABLE 29
1D array D

| | | |
|---|---|---|
| 4 | 5 | 11 |

Link

| | | |
|---|---|---|
| — | — | — |

Following the operations of the 1D MaxPool operation of FIG. 5, a 1D output array after 1D MaxPool is complete on 1D input array D is shown in Table 30:

TABLE 30
1D Output

| | |
|---|---|
| 5 | 11 |

After the 1D MaxPool output has been calculated for the first column of the current 2D input array, the flow returns to step 410, shown and described with respect to FIG. 4. Step 410 is now complete, and the process continues to step 412, where the intermediate output array for the current dimension is updated with the values calculated by the 1D MaxPool operation. Here, the first column of the intermediate output array is updated with the values of the 1D MaxPool of the first column of the second dimension of the 2D input array. Table 31 shows the state of the intermediate output array at this point.

TABLE 31
Intermediate output

5
11

After the intermediate output array is updated in step 412, the array counter a is incremented in step 414 (a=1), and the flow continues to 408. On condition 408 that not all 1D arrays in the current dimension of the current 2D input array have been considered (i.e., a<the number of arrays in the current dimension), a 1D MaxPool operation is carried out on the a^{th} array of the d^{th} dimension in step 410. In this example, the 1^{th} dimension corresponds to columns of the input 2D array, and array 1 is the second column, shown in Table 32.

TABLE 32
4
10
10

Transposing this array for convenience of illustration, the 1D input array D is shown in Table 33:

TABLE 33
1D array D

| | | |
|---|---|---|
| 4 | 10 | 10 |

Link

| | | |
|---|---|---|
| — | — | — |

Following the operations of the 1D MaxPool operation of FIG. 5, a 1D output array after 1D MaxPool is complete on 1D input array D is shown in Table 34:

TABLE 34
1D Output

| | |
|---|---|
| 10 | 10 |

After the 1D MaxPool output has been calculated for the second column of the current 2D input array, the flow returns to step 410, shown and described with respect to FIG. 4. Step 410 is now complete, and the process continues to step 412, where the intermediate output array for the current dimension is updated with the values calculated by the 1D MaxPool operation. Here, the second column of the intermediate output array is updated with the values of the 1D MaxPool of the second column of the second dimension of the current 2D input array. Table 35 shows the state of the intermediate output array at this mint.

TABLE 35
Intermediate Output

| | |
|---|---|
| 5 | 10 |
| 11 | 10 |

After the intermediate output array is updated in step 412, the array counter a is incremented in step 414 (a=2), and the flow continues to 418. On condition 408 that all 1D arrays in the current dimension have been considered (i.e., a!<the number of arrays in the current dimension—here, 2!<2), the intermediate output array is set as the input array, dimension counter d is incremented in step 416, and the flow proceeds to 406.

The 2D input data array now reflects what was the intermediate output array, the intermediate output array is cleared, and array counter a is reset to 0. It is noted that the input array is still a 2D array, however it is now 2 elements in width, and 2 elements in height. The current 2D input data array is shown in Table 36, and the cleared intermediate output array is shown in Table 37.

TABLE 36
2D Input

| | |
|---|---|
| 5 | 10 |
| 11 | 10 |

TABLE 37
Intermediate Output

On condition 406 that all dimensions of the input array have been considered yet (i.e., d!<the number of dimensions, here, 2!<2), 1D MaxPool operations have been performed on all 1D arrays in the row and column directions of the input 2D array, as described above, and the flow proceeds to step 418, where the current input array is output as the final 2D output, as shown in Table 38:

TABLE 38
Final 2D Output

| | |
|---|---|
| 5 | 10 |
| 11 | 10 |

The output shown in Table 38 reflects the final 2D MaxPool result for the 2D input Array, for kernel size K=2. It is noted that this technique is extendible for input arrays of higher dimensions (i.e., 3D, 4D, and above).

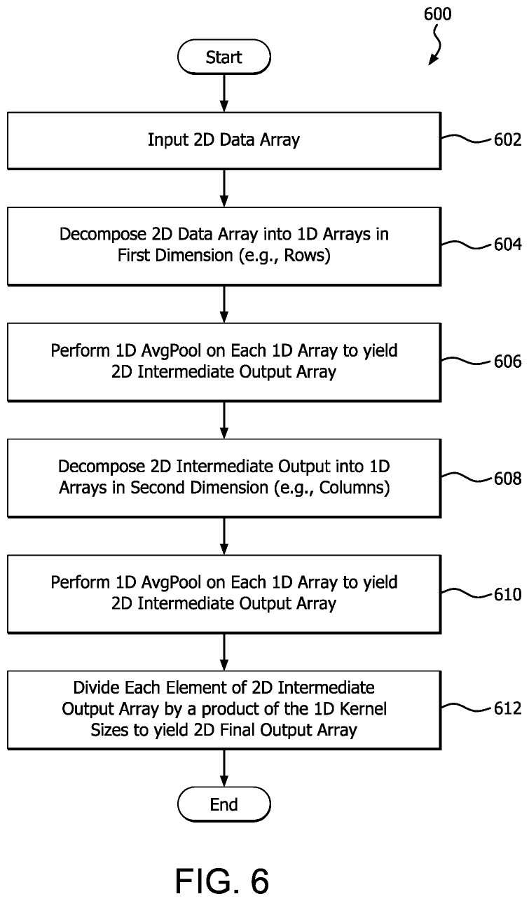

FIG. 6 is a flow chart illustrating an example method 600 for AvgPool on an input array of 2 dimensions on a computing device. The method is expandable to any desired number of dimensions, as further discussed herein. Example method 600 is implementable using any suitable hardware and/or software, such as device 100 or components thereof, e.g., as shown and described with respect to FIGS. 1 and 2.

Example method 600 is discussed with respect to a 2D input array which is input in step 602, however it is noted that an input array of any desired number of dimensions is possible in some implementations. Table 39 shows the values of the example 2D input array.

TABLE 39
2D Input Array

| | | |
|---|---|---|
| 2 | 10 | 5 |
| 4 | 1 | 2 |
| 7 | 9 | 6 |

For example, in order to compute the 2D AvgPool result for an example 2D input array, the 2D input array is decomposed into 1D arrays in a first dimension (the row dimension in this example) in step 604. A 1D AvgPool operation is performed on each of these 1D arrays to yield an intermediate 2D result for the first dimension in step 606. The example intermediate 2D result is shown in Table 40.

TABLE 40
Intermediate 2D
AvgPool Result

| | |
|---|---|
| 12 | 15 |
| 5 | 3 |
| 16 | 15 |

This intermediate output is decomposed into 1D arrays in the second dimension (the column dimension in this example) in step 608, and a 1D AvgPool operation is performed on each of these 1D arrays to yield a second intermediate 2D result for the second dimension in step 610. The 2D result for the second dimension is shown in Table 41.

TABLE 41
Second Intermediate
2D AvgPool Result

| | |
|---|---|
| 17 | 18 |
| 21 | 18 |

For higher dimensionality AvgPool operations on input arrays of higher dimensions, an intermediate result is generated and decomposed into 1D arrays for 1D MaxPool operations for each further dimension until all dimensions have been calculated. Each element of the final intermediate result (the second intermediate 2D AvgPool Result for this example 2D case), is divided by a product of the 1D kernel sizes to yield a final 2D AvgPool output array in step 612. The final 2D AvgPool output array is shown in Table 42.

TABLE 42
Final 2D AvgPool Result

| | |
|---|---|
| 4.25 | 4.5 |
| 5.25 | 4.5 |

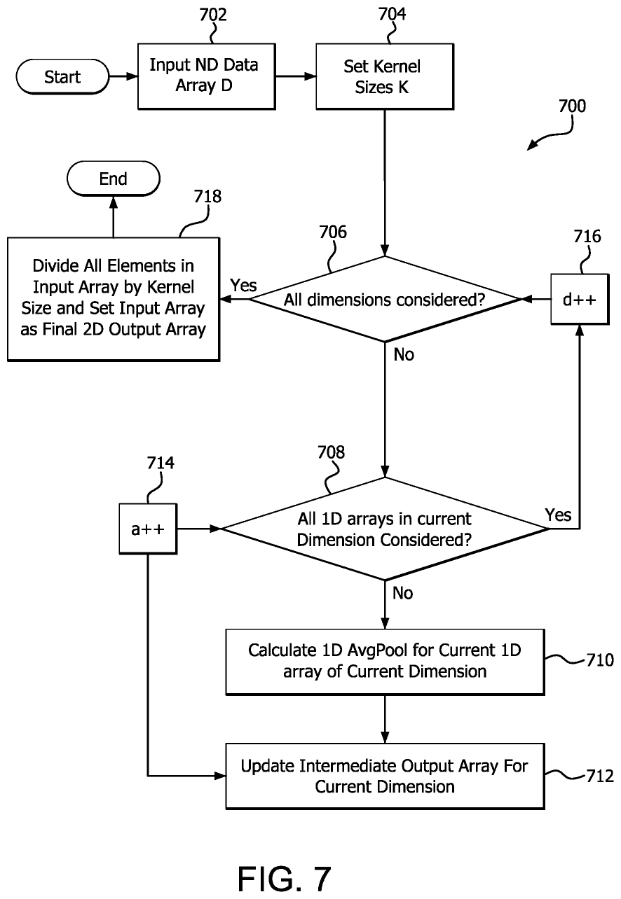

FIG. 7 is a flowchart illustrating an example method 700 for AvgPool on an input array of arbitrary dimensions on a computing device. The method is expandable to any desired number of dimensions, as further discussed herein. Example method 700 is implementable using any suitable hardware and/or software, such as device 100 or components thereof, e.g., as shown and described with respect to FIGS. 1 and 2. In some implementations, example method 700 is a more detailed description of method 600 as shown and described with respect to FIG. 6, and is described using the same example 2D input array.

In step 702, the 2D array is input for AvgPool computation. The example input array is 2D with one row dimension, and one column dimension. The example input array is 3 elements in width (or, row size of 3), and 3 elements in height (or, column size of 3). Table 43 shows values of the example 2D input array.

TABLE 43
2D Input Array

| | | |
|---|---|---|
| 2 | 10 | 5 |
| 4 | 1 | 2 |
| 7 | 9 | 6 |

In step 704, kernel sizes are set for each dimension of the 2D input array. In this example, the kernel sizes are 2 for the row dimension, and 2 for the column dimension. After the 2D data array and the kernel sizes are input in steps 702 and 704, an iteration counter d is initialized to 0 for tracking each dimension, and an iteration counter a is initialized to 0 for tracking each array in a dimension. It is noted that the use of an index variable is only a convenient example; any other suitable approach to tracking which dimension and/or array is under consideration is usable in other implementations. The illustrated order of steps 702, 704, and initialization of the iteration counters, is simply for convenience. These steps are implementable in any suitable order, simultaneously, and/or concurrently, as desired.

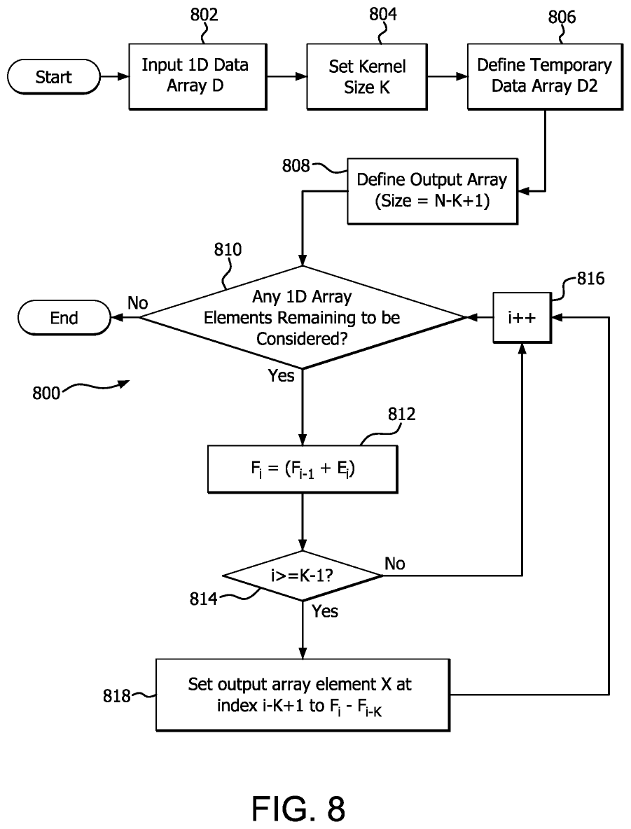

On condition 706 that not all dimensions of the input array have been considered yet (i.e., d<the number of dimensions) and on condition 708 that not all 1D arrays in the current dimension have been considered (i.e., a<the number of arrays in the current dimension), a 1D AvgPool operation is carried out on the a^{th} array of the d^{th} dimension in step 710. In this example, the 0^{th} dimension corresponds to rows of the input 2D array, and array 0 is the first row. Accordingly, the values of this 1D array are as shown in Table 43. The 1D AvgPool operation carried out in step 710 is described in detail with respect to FIG. 8.

TABLE 43

| | | |
|---|---|---|
| 2 | 10 | 5 |

FIG. 8 is a flowchart illustrating an example method 800 for computing 1D AvgPool on a computing device. The one dimensional (1D) array of Table 43 is input to the 1D AvgPool operation in step 802.

44 shows example 1D input array D, which includes 3 elements E. The size of array D is referred to as D_{size}, and is 3 in this example. In this example, the elements are indexed and referred to as E₀, E₁, E₂, respectively. Each element is associated with a value. In this example, E₀ is associated with the value 2, E₁ is associated with the value 10, and E₂ is associated with the value 5. Input array D is illustrated in Table 44.

TABLE 44
1D Input Array

| E₀ | E₁ | E₂ |
|---|---|---|
| 2 | 10 | 5 |

In this example, an index variable i is used to track which element E is under consideration, and accordingly, i is initialized to 0 (i==0). It is noted that the use of an index variable is only a convenient example; any other suitable approach to tracking which element E is under consideration is usable in other implementations.

In step 804, a kernel size K is set for the 1D AvgPool operation. In this example, the size K of the AvgPool kernel is 2, based on the kernel set for this dimension earlier in step 704 shown and described with respect to FIG. 7. In step 806, a 1D array D is defined to hold temporary data. D2 is the same size as 1D input array D (i.e., Dsize), which is 3 in this example. D2 is also referred to as a sum array. In this example, the elements of D2 are indexed and referred to as F₀, F₁, F₂, respectively. Each element is associated with a value. The initialized sum array D is illustrated in Table 45.

TABLE 45
Sum array

| F₀ | F₁ | F₂ |
|---|---|---|
| — | — | — |

In step 808, a 1D output array of size N−K+1 is defined for storing the output of the 1D AvgPool operation on input array D1. Table 46 shows the initialized output array.

TABLE 46
1D Output

On condition 810 that any of the elements E of array D have not yet been evaluated, the 1D AvgPool operation proceeds. Here, since none of the elements of array D have yet been considered (i.e., i=0, i<(Dsize)), the first element E₀ is considered (i.e., Eᵢ, where i=0). Accordingly, Ei is set to the value of the first element of the input array (i.e., Eᵢ==2).

In step 812, Fi is calculated as Fᵢ==(Fᵢ₋₁+Eᵢ). Negative indices are considered to correspond to zero-values for this purpose. Accordingly, F₀=(F₋₁+E₀)=(0+2)=2. The current state of sum array D is illustrated in Table 47.

TABLE 47
Sum array

| F₀ | F₁ | F₂ |
|---|---|---|
| 2 | — | — |

After Fᵢ is calculated, a determination is made as to whether the index number i of element Eᵢ under consideration is greater than or equal to K−1. This determination is made so that a sufficient number of elements are considered (i.e., K elements—a complete kernel) before further calculations are made on the kernel. Accordingly, on condition 814 that i>=K−1, the process continues, otherwise, i is incremented at step 816 and the process returns to condition 810 for consideration of the next element. Here, element E₀ is under consideration, and 0 is not greater than or equal to one less than the kernel size (i.e., 0 !>=2−1). Accordingly, i is incremented (i.e., i++, where i is now equal to 1) at step 816 and the flow returns to condition 810.

On condition 810 that any of the elements E of array D have not yet been evaluated, the 1D AvgPool operation proceeds. Here, since not all of the elements of array D have yet been considered (i.e., i=1, i<(D_{size})) the current element E₁ is considered (i.e., Eᵢ, where i=1). Accordingly, Eᵢ is set to the value of the i^{th} element of the input array (i.e., Eᵢ==10).

In step 812, F₁ is calculated as Fᵢ==(Fᵢ₋₁+Eᵢ). Accordingly, F1=(F₀+E₁)=(2+10)=12. The current state of sum array D is illustrated in Table 48.

TABLE 48
Sum array

| F₀ | F₁ | F₂ |
|---|---|---|
| 2 | 12 | — |

After F₁ is calculated, a determination is made as to whether the index number i of element Eᵢ under consideration is greater than or equal to K−1. This determination is made so that a sufficient number of elements are considered (i.e., K elements—a complete kernel) before further calculations are made on the kernel. Accordingly, on condition 814 that i>=K−1, the process continues, otherwise, i is incremented at step 816 and the process returns to condition 810 for consideration of the next element. Here, element E₁ is under consideration, and 1 is greater than or equal to one less than the kernel size (i.e., 1>=2−1). Accordingly, the flow continues to step 818.

In step 818, the output at index i−K+1=Fᵢ−F_{i-K}. Here, the output at index 1−2+1=F₁−F₁₋₂. In other words, the output at index 0=F₁−F₋₁. Since negative indices are treated as zero values, the output at index 0=F₁−0=12−0=12. Table 49 shows the output array at this point.

TABLE 49
1D Output

| | |
|---|---|
| 12 | — |

After the output at index i is computed in 818, i is incremented (i.e., i++, where i is now equal to 2) at step 816 and the flow returns to condition 810.

On condition 810 that any of the elements E of array D have not yet been evaluated, the 1D AvgPool operation proceeds. Here, since not all of the elements of array D have yet been considered (i.e., i=2, i<(D_{size})), the current element E₂ is considered (i.e., Eᵢ, where i=2). Accordingly, Ei is set to the value of the i^{th} element of the input array (i.e., Eᵢ==5).

In step 812, Fᵢ is calculated as Fᵢ==(Fᵢ₋₁+Eᵢ). Accordingly, F2=(F₁+E₂)=(12+5)=17. The current state of sum array D is illustrated in Table 50.

TABLE 50
Sum array

| | | |
|---|---|---|
| 2 | 12 | 17 |

After Fᵢ is calculated, a determination is made as to whether the index number i of element Eᵢ under consideration is greater than or equal to K−1. This determination is made so that a sufficient number of elements are considered (i.e., K elements—a complete kernel) before further calculations are made on the kernel. Accordingly, on condition 814 that i>=K−1, the process continues, otherwise, i is incremented at step 816 and the process returns to condition 810 for consideration of the next element. Here, element E₂ is under consideration, and 2 is greater than or equal to one less than the kernel size (i.e., 2>=2−1). Accordingly, the flow continues to step 818.

In step 818, the output at index i−K+1=Fᵢ−F_{i-K}. Plugging in values, the output at index 2−2+1=F₂−F₂₋₂. In other words, the output at index 1=F₂−F₀. Accordingly, the output at index 1=17−2=15. Table 51 shows the output array at this point.

TABLE 51
Output

| | |
|---|---|
| 12 | 15 |

After the output at index i is computed in 818, i is incremented (i.e., i++, where i is now equal to 3) at step 816 and the flow returns to condition 810. On condition 810 that any of the elements E of array D have not yet been evaluated, the 1D AvgPool operation proceeds. Here, all of the elements of array D have been considered (i.e., i=3, i!<(D_{size})). Accordingly, the 1D AvgPool operation is complete with respect to the current input array D.

At this point, the 1D AvgPool output has been calculated for the first row of the 2D input array, and the flow returns to step 710, shown and described with respect to FIG. 7. Step 710 is now complete, and the process continues to step 712, where the intermediate output array for the current dimension is updated with the values calculated by the 1D AvgPool operation. Here, the first row of the intermediate output array is updated with the values of the 1D AvgPool of the first row of the first dimension of the 2D input array. Table 52 shows the state of the intermediate output array at this point.

TABLE 52
Intermediate Output

| | |
|---|---|
| 12 | 15 |

After the intermediate output array is updated in step 712, the array counter a is incremented in step 714 (a=1), and the flow continues to condition 708. On condition 708 that not all 1D arrays in the current dimension have been considered (i.e., a<the number of arrays in the current dimension), a 1D AvgPool operation is carried out on the a^{th} array of the d^{th} dimension in step 710. In this example, the 0^{th} dimension corresponds to rows of the input 2D array, and array 1 is the second row, shown in Table 53.

TABLE 53

| | | |
|---|---|---|
| 4 | 1 | 2 |

Following the 1D AvgPool operations described with respect to FIG. 8, the output array after 1D AvgPool is complete on the 1D input array is shown in Table 54:

TABLE 54
1D Output

| | |
|---|---|
| 5 | 3 |

At this point, the 1D AvgPool output has been calculated for the second row of the 2D input array, and the flow returns to step 712, shown and described with respect to FIG. 7. Step 710 is now complete, and the process continues to step 712, where the intermediate output array for the current dimension is updated with the values calculated by the 1D AvgPool operation. Here, the second row of the intermediate output array is updated with the values of the 1D AvgPool of the second row of the first dimension of the 2D input array. Table 55 shows the state of the intermediate output array at this point.

TABLE 55
Intermediate Output

| | |
|---|---|
| 12 | 15 |
| 5 | 3 |

After the intermediate output array is updated in step 712, the array counter a is incremented in step 714 (a=2), and the flow continues to condition 708. On condition 708 that not all 1D arrays in the current dimension of the 2D input array have been considered (i.e., a<the number of arrays in the current dimension), a 1D AvgPool operation is carried out on the a^{th} array of the d^{th} dimension in step 710. In this example, the 0^{th} dimension corresponds to rows of the input 2D array, and array 2 is the third row, shown in Table 56.

TABLE 56

| | | |
|---|---|---|
| 7 | 9 | 6 |

Following the 1D AvgPool operations described with respect to FIG. 8, the output array after 1D AvgPool is complete on 1D input array is shown in Table 57:

TABLE 57
1D Output

| | |
|---|---|
| 16 | 15 |

At this point, the 1D AvgPool output has been calculated for the third row of the 2D input array, and the flow returns to step 710, shown and described with respect to FIG. 7. Step 710 is now complete, and the process continues to step 712, where the intermediate output array for the current dimension is updated with the values calculated by the 1D AvgPool operation. Here, the third row of the intermediate output array is updated with the values of the 1D AvgPool of the third row of the first dimension of the 2D input array. Table 58 shows the state of the intermediate output array at this point.

TABLE 58
Intermediate
Output

| | |
|---|---|
| 12 | 15 |
| 5 | 3 |
| 16 | 15 |

After the intermediate output array is updated in step 712, the array counter a is incremented in step 714 (a=3), and the flow continues to condition 708. On condition 708 that all 1D arrays in the current dimension have been considered (i.e., a!<the number of arrays in the current dimension—here, 3!<3), the intermediate output array is set as the input array, dimension counter d is incremented in step 716, and the flow proceeds to 706.

The input data array now reflects what was the intermediate output array, the intermediate output array is cleared, and array counter a is reset to 0. It is noted that the input array is still a 2D array, however it is now 2 elements in width, and 3 elements in height. The current input data array is shown in Table 59, and the cleared intermediate output array is shown in Table 60.

TABLE 59
Input

| | |
|---|---|
| 12 | 15 |
| 5 | 3 |
| 16 | 15 |

TABLE 60
Intermediate
Output

On condition 706 that not all dimensions of the input array have been considered yet (i.e., d<the number of dimensions) and on condition 708 that not all 1D arrays in the current dimension of the current 2D input array have been considered (i.e., a<the number of arrays in the current dimension), a 1D AvgPool operation is carried out on the a^{th} array of the d^{th} dimension in step 710. In other words, since dimension 1<2, and array 0<2, a 1D AvgPool operation is carried out on the 0^{th} array of the 1^{th} dimension in step 710. In this example, the 1^{th} dimension corresponds to the columns of the current input 2D array, and array 0 is the first column, shown in Table 61.

TABLE 61
12
5
16

Transposing this array for convenience of illustration, the 1D input array D, is shown in Table 62:

TABLE 62

| | | |
|---|---|---|
| 12 | 5 | 16 |

Following the operations of the 1D AvgPool operation of FIG. 8, a 1D output array after 1D AvgPool is complete on the 1D input array is shown in Table 63:

TABLE 63
1D Output

| | |
|---|---|
| 17 | 21 |

After the 1D AvgPool output has been calculated for the first column of the current 2D input array, the flow returns to step 710, shown and described with respect to FIG. 7. Step 710 is now complete, and the process continues to step 712, where the intermediate output array for the current dimension is updated with the values calculated by the 1D AvgPool operation. Here, the first column of the intermediate output array is updated with the values of the 1D AvgPool of the first column of the second dimension of the 2D input array. Table 64 shows the state of the intermediate output array at this point.

TABLE 64
Intermediate
Output

17
21

After the intermediate output array is updated in step 712, the array counter a is incremented in step 714 (a=1), and the flow continues to condition 708. On condition 708 that not all 1D arrays in the current dimension of the current 2D input array have been considered (i.e., a<the number of arrays in the current dimension), a 1D AvgPool operation is carried out on the a^{th} array of the d^{th} dimension in step 710. In this example, the 1^{th} dimension corresponds to columns of the input 2D array, and array 1 is the second column, shown in Table 65.

TABLE 65
15
3
15

Transposing this array for convenience of illustration, the 1D input array D is shown in Table 66:

TABLE 66

| | | |
|---|---|---|
| 15 | 3 | 15 |

Following the operations of the 1D AvgPool operation of FIG. 8, an output array after 1D AvgPool is complete on the 1D input array is shown in Table 67:

TABLE 67
1D Output

| | |
|---|---|
| 18 | 18 |

After the 1D AvgPool output has been calculated for the second column of the current 2D input array, the flow returns to step 710, shown and described with respect to FIG. 7. Step 710 is now complete, and the process continues to step 712, where the intermediate output array for the current dimension is updated with the values calculated by the 1D AvgPool operation. Here, the second column of the intermediate output array is updated with the values of the 1D AvgPool of the second column of the second dimension of the current 2D input array. Table 68 shows the state of the intermediate output array at this point.

TABLE 68
Intermediate
Output

| | |
|---|---|
| 17 | 18 |
| 21 | 18 |

After the intermediate output array is updated in step 712, the array counter a is incremented in step 714 (a=2), and the flow continues to condition 708. On condition 708 that all 1D arrays in the current dimension have been considered (i.e., a!<the number of arrays in the current dimension—here, 2!<2), the intermediate output array is set as the input array, dimension counter d is incremented in step 716, and the flow proceeds to condition 706.

The input data array now reflects what was the intermediate output array, the intermediate output array is cleared, and array counter a is reset to 0. It is noted that the input array is still a 2D array, however it is now 2 elements in width, and 2 elements in height. The current input data array is shown in Table 69, and the cleared intermediate output array is shown in Table 70.

TABLE 69
Input

| | |
|---|---|
| 17 | 18 |
| 21 | 18 |

TABLE 70
Intermediate
Output

On condition 706 that all dimensions of the input array have been considered (i.e., d!<the number of dimensions, here, 2!<2), 1D AvgPool operations have been performed on all 1D arrays in the row and column directions of the input 2D array, as described above, and the flow proceeds to step 718. In order to calculate the final 2D AvgPool output array all elements of the current 2D input array are divided by the 2D kernel size (i.e., the number of elements in the kernel), which is the product of the 1D kernel sizes. Here, the 1D kernel size is 2 in each dimension for each of the component 1D arrays. Accordingly, each element is divided by 2×2; i.e., by 4, to calculate averages, as shown in Table 71.

TABLE 71
Output

| | |
|---|---|
| 17/4 | 18/4 |
| 21/4 | 18/4 |

Thus, the final 2D AvgPool output array for this example is shown in Table 72.

TABLE 72
Output

| | |
|---|---|
| 4.25 | 4.5 |
| 5.25 | 4.5 |

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for determining N-dimensional MaxPool for a M-dimensional input array in a computing device, the method comprising:
for each of N dimensions, in order from highest to lowest dimension i:
decomposing the M dimensional input array into 1 dimensional (1D) input arrays in the i^{th} dimension,
performing 1D MaxPool on each of the 1D input arrays in the i^{th} dimension to generate 1D output arrays in the i^{th} dimension, and
recomposing the M dimensional input array from the 1D output arrays in the i^{th} dimension to update the M-dimensional input array; and
outputting the updated M-dimensional input array as an M-dimensional output array.

2. The method of claim 1, wherein the 1D output array for each of the 1D input arrays in the i^{th} dimension is calculated with respect to a kernel size.

3. The method of claim 2, wherein the kernel sizes of at least two of the i dimensions are different.

4. The method of claim 1, wherein determining the 1D output array comprises tracking a highest valued element of the 1D input array in a stack of pointers to elements of the 1D input array.

5. The method of claim 1, wherein determining the 1D output array comprises tracking the highest valued element of a 1D input array by links associated with each element of the 1D input array.

6. The method of claim 5, further comprising tracking the highest valued element by following each of the links until reaching a link pointing to its own element.

7. A method for determining N-dimensional AvgPool for a M-dimensional input array in a computing device, the method comprising:
for each of N dimensions, in order from highest to lowest dimension i:
decomposing the M-dimensional input array into 1 dimensional (1D) input arrays in i^{th} dimension,
performing 1D AvgPool on each of the 1D input arrays in the i^{th} dimension to generate 1D output arrays in the i^{th}; and
recomposing the M dimensional input array from the 1D output arrays in the i^{th} dimension to update the M-dimensional input array; and
dividing each of element of the updated M-dimensional input array by a kernel size to form an M-dimensional output array; and
outputting the M-dimensional output array.

8. The method of claim 7, wherein the 1D output array for each of the 1D input arrays in the i^{th} dimension is calculated with respect to a kernel size.

9. The method of claim 8, wherein the kernel size is different for at least two of the i dimensions.

10. The method of claim 7, further comprising accumulating a sum of elements of each of the 1D input arrays in a corresponding sum array.

11. The method of claim 10, wherein determining the 1D output array comprises subtracting a value of an element of the sum array from a value of a different element of the sum array.

12. An apparatus for determining N-dimensional MaxPool for a M-dimensional input array, the apparatus comprising:
circuitry configured to, for each of N dimensions, in order from highest to lowest dimension i:
decompose the M-dimensional input array into 1 dimensional (1D) input arrays in i^{th} dimension,
perform 1D MaxPool on each of the 1D input arrays in the i^{th} dimension to generate 1D output arrays in the i^{th} dimension, and
recompose the M dimensional input array from the 1D output arrays in the i^{th} dimension to update the M dimensional input array; and
circuitry configured to output the updated M-dimensional input array as an M-dimensional output array.

13. The apparatus of claim 12, further comprising circuitry configured to calculate the 1D output array for each of the 1D input arrays in the i^{th} dimension with respect to a kernel size.

14. The apparatus of claim 13, wherein the kernel sizes of at least two of the i dimensions are different.

15. The apparatus of claim 12, further comprising circuitry configured to determine the 1D output array by tracking a highest valued element of the 1D input array in a stack of pointers to elements of the 1D input array.

16. The apparatus of claim 12, further comprising circuitry configured to determine the 1D output array by tracking the highest valued element of a 1D input array by links associated with each element of the 1D input array.

17. The apparatus of claim 16, further comprising circuitry configured to track the highest valued element by following each of the links until reaching a link pointing to its own element.

18. An apparatus for determining N-dimensional AvgPool for a M-dimensional input array, the apparatus comprising:
circuitry configured to, for each of N dimensions, in order from highest to lowest dimension i:
decompose the M-dimensional input array into 1 dimensional (1D) input arrays in i^{th} dimension,
perform 1D AvgPool on each of the 1D input arrays in the i^{th} dimension to generate 1D output arrays in the i^{th}; and
recompose the M dimensional input array from the 1D output arrays in the i^{th} dimension to update the M-dimensional input array; and
circuitry configured to divide each of element of the updated M-dimensional input array by a kernel size to form an M-dimensional output array; and
circuitry configured to output the M-dimensional output array.

19. The apparatus of claim 18, further comprising circuitry configured to calculate the 1D output array for each of the 1D input arrays in the i^{th} dimension with respect to a kernel size.

20. The apparatus of claim 19, wherein the kernel size is different for at least two of the i dimensions.

21. The apparatus of claim 18, further comprising circuitry configured to accumulate a sum of elements of each of the 1D input arrays in a corresponding sum array.

22. The apparatus of claim 21, circuitry configured to determine the 1D output array by subtracting a value of an element of the sum array from a value of a different element of the sum array.
